(19) United States
(12) Patent Application Publication
(10) Pub. No.: US 2006/0039715 A1
(43) Pub. Date: Feb. 23, 2006

(54) Electrostatographic apparatus with cleaning device for controlling release oil transfer

(75) Inventors: Donald S. Rimai, Webster, NY (US); Jordan D. Cormier, Westminster, MA (US); Biao Tan, Rochester, NY (US); Michael T. Regan, Fairport, NY (US)

Correspondence Address: Lawrence P. Kessler;Patent Legal Staff, Eastman Kodak Company, 343 State Street, Rochester, NY, 14650-2201, US

(73) Assignee: Eastman Kodak Company

(21) Appl. No.: 10/921,716

(22) Filed: Aug. 19, 2004

(51) Int. Cl. G03G 21/00

(52) U.S. Cl. 399/91

(57) ABSTRACT

An electrostatographic reproduction apparatus comprising: a primary imaging member for forming a toner image, a fuser assembly containing a fusing member and a pressure member for fixing the toner image to a receiver, a release oil device for delivering release oil to the fusing member of the fuser assembly, an intermediate transfer member for receiving the toner image from the primary imaging member, and a receiver transport member for transporting the toner image from the intermediate transfer member to the fuser assembly. The receiver transport member has a surface energy from about 14 ergs/cm² to about 35 ergs/cm². The apparatus further includes a cleaning device that is associated with the receiver transport member and includes a fabric material capable of removal of residual release oil from the receiver transport member.

### FIELD OF THE INVENTION

The present invention relates in general to electrophotographic imaging and more particularly to an electrostatographic reproduction apparatus having a cleaning device for reducing the transfer of residual release oil from one member of the apparatus to another.

### BACKGROUND OF THE INVENTION

In typical commercial reproduction apparatus such as electrostatographic copiers/duplicators, printers, and the like, an electrostatic latent image is first formed by imagewise exposure, using an illumination source such as an LED array, laser scanner or flash lamp, of a photoconductive primary imaging member having an initial uniform electrical charge. The primary imaging member bearing the electrostatic latent image is then brought into close proximity to a development station where charge marking particles, often referred to as toner or dry ink particles, are imagewise deposited onto the primary imaging member, thereby transforming the latent image into a visible image. The developed image may then be transferred to a receiver such as paper by application of an electrostatic field.

Alternatively, the image can be first transferred to an intermediate member such as a compliant intermediate member and subsequently transferred from the intermediate member to the receiver. Intermediate transfer members, which are discussed in, for example, U.S. Pat. Nos. 5,084,735 and 5,698,787, the disclosures of which are incorporated herein by reference, are useful in electrophotography for a number of reasons, including simplified receiving sheet handling, single pass duplexing, saving wear on photoconductors and superposition of images to form multi-color images. Typically, a toner image is created on a photoconductive member electrophotographically, and is then transferred to an intermediate transfer member, such as a roller or web. For example, a negatively charged toner image is transferred from a photoconductor having an electrically grounded backing electrode, to an intermediate web or roller biased to a strong positive polarity. The toner image is then transferred from the intermediate member to a receiving sheet under the influence of a second electric field. The second electric field can be created, without changing the voltage on the intermediate member, by placing a roller behind the receiving sheet, which is biased in a stronger, positive direction.

The most desirable use of intermediate transfer is for creating multi-color images. When an intermediate transfer member is used, two, three, four or more separate images of different color can be transferred in registration to the intermediate transfer member to create a multi-color image. The multi-color image can then be transferred in one step to the receiving sheet. This system has a number of advantages over the more conventional approach to making multi-color images in which the receiver sheet is secured to the periphery of a roller and rotated repeatedly into transfer relation with the photoconductor to receive the color images directly. The most important advantage is that the receiving sheet itself does not have to be attached to a roller. Attaching the receiving sheet to a roller has been a source of misregistration of images due to independently transferring each color image to the receiver, as well as complexity in apparatus. Other advantages, such as wear and tear on the photoconductive member and a straight and simple receiving sheet path are also important.

High resolution in electrophotographic color printing is desirable. In order to obtain higher resolution, fine toners are necessary. Toners less than 20 μm, and especially less than 10 μm in size, give substantially improved resolution in color imaging with high quality equipment. Unfortunately, fine toners are more difficult to transfer electrostatically than are traditional coarse toners. This is a problem using both single transfer and intermediate transfer members.

When transferring toners having a volume weighted average diameter less than 12 μm, and using electrostatics at both transfers, a number of transfer artifacts occur. For example, a well known artifact called “hollow character” is a result of insufficient transfer in the middle of high density toned areas, e.g., in alphanumerics. Another artifact, “halo” is experienced when toner fails to transfer next to a dense portion of an image. These problems cannot be eliminated merely by an increase of the transfer field, since that expedient is limited by electrical breakdown.

Color images are made by first forming electrostatic latent images corresponding to the primary colors, often referred to as separations, then developing those latent images with the appropriately colored toner particles. Similarly, images including a custom spot color can be made using separations corresponding to the custom spot colors. These images are ultimately transferred in register to a receiver, either directly or via a transfer intermediate member.

After the toned image has been transferred to the receiver, it has to be permanently fixed, or fused, typically by passing the image-bearing receiver between two rollers, at least one of which is heated to a temperature in excess of the glass transition temperature T_{g} of the toner particles. The combination of heat and pressure is sufficient to allow the particles to soften and bond to each other and the receiver.

Low melting point marking particles are subject to increased image offset to the heating roller. This can produce undesirable defects in the reproduction or subsequent reproductions. Although image offset can be reduced by application of fusing oil to the heating roller, the use of such oil introduces further complications into the fusing system, such as handling of the oil and making sure that the layer of oil on the roller is uniform.

With roller fuser assemblies, it is common practice to use release fluids applied to the fuser roller surface to improve the release of image-carrying receiver members from the fuser roller. The most common types of release fluid applicators or oilers are a rotating wick roller, a donor/metering roller, an oil impregnated oiling web, an oil impregnated oiling pad or roller, or variations or combinations of the above. The release oil applied to the fuser roller tends to migrate from the fuser roller to the opposing pressure roller. This occurs, for example, between receiver members passing through the fuser assembly. Oil on the pressure roller can be deposited on subsequent receiver members such as a receiver transport web, leading to deleterious artifacts on the copies being reproduced and making them unacceptable for their intended use.

Silicones, either as pure silicone oils or in combination with functionally terminated groups, are commonly used as release oils because of their low surface tension, typically approximately 25 mN/m, and their low volatility. Unfortunately, the same physical properties that make such materials desirable for use as release oils also facilitate their tendency to create image artifacts and their transfer from one member of the apparatus to another, and hamper their removal from a given member.

An electrophotographic apparatus capable of producing color images contains multiple modules, each including a charger, primary imaging member, and a compliant transfer intermediate member. A polymeric transport web that transports the receiver also serves to frictionally drive each module. When the receiver is flipped to its reverse side, oil that had been transferred to the receiver during fusing can now be transferred to the transport web, from which it can be transferred to the transfer intermediate member and from there to the primary imaging member. Oil transferred to the primary imaging member changes the surface characteristics of that member, causing variations in the amount of toner deposited on oil-containing areas relative to those areas containing no oil. In addition, the presence or absence of fuser oil can also affect transfer efficiency, causing further density variations of the image on the final receiver. To reduce artifacts caused by residual release oil, particularly in duplex copying, U.S. Pat. No. 6,654,584, the disclosure of which is incorporated herein by reference, describes a cleaning device for cleaning a pressure member of a fuser assembly. The device includes a fabric material adapted to be impregnated with release oil, which is to applied in a uniform thin layer to the pressure member surface.

For a fuser oil to work as a release agent in an electrophotographic fusing system, it must first spread uniformly over both contacting surfaces. Secondly, it must have a low shear strength so that the layer of deposited oil fractures readily, permitting easy separation of the two contacting surfaces. In the absence of the fuser oil, the surfaces would tend to bond together. Furthermore, to facilitate its spread over both surfaces, the oil should have a surface energy that is significantly lower than either of the mating surfaces.

In general, the removal of fuser oil from a surface is problematic. Although it is possible to remove much of the oil in instances where the oil coating is relatively thick, as on a fuser roller, the removal of a very thin coating is much more difficult because there is insufficient oil to permit cohesive fracture of the layer. Moreover, it is generally energetically unfavorable to remove thin layers of oil from a surface, as propagating a fracture plane down an interface would involve what is known as an adhesive (as opposed to cohesive) failure. Unfortunately, experimental results strongly suggest that it takes only a very thin layer of fuser oil to cause serious toner image degradation.

The present invention provides for eliminating or substantially reducing the amount of residual release oil available for transfer from one member of an electrostatographic reproduction apparatus to another, in particular, by removing a substantial amount of residual oil from the receiver transport member of the apparatus.

### SUMMARY OF THE INVENTION

The present invention is directed to an electrostatographic reproduction apparatus that includes: a primary imaging member for forming a toner image, a fuser assembly containing a fusing member and a pressure member for fixing the toner image to a receiver, a release oil device for delivering release oil to the fusing member of the fuser assembly, an intermediate transfer member for receiving the toner image from the primary imaging member, and a receiver transport member for transporting the toner image from the intermediate transfer member to the fuser assembly. The receiver transport member has a surface energy from about 14 ergs/cm² to about 35 ergs/cm². The apparatus further includes a cleaning device that is associated with the receiver transport member and includes a fabric material capable of removal of residual release oil from the receiver transport member.

### BRIEF DESCRIPTION OF THE DRAWINGS

FIG. 1 schematically depicts an electrostatographic reproduction apparatus suitable for the practice of the present invention;

FIG. 2 graphically depicts surface energy measurements for a sequence of transfers of silicone oil from one substrate to another; and

FIG. 3 graphically depicts surface energy measurements for a sequence of acceptor substrates that had been contacted with a donor substrate containing applied silicone oil.

### DETAILED DESCRIPTION OF THE INVENTION

In the practice of the present invention, an electrostatographic reproduction apparatus preferably includes two or more modules, each of which includes a development station, an intermediate member that is preferably compliant, and a primary imaging member. A receiver transport device, preferably a transport web, transports the receiver through each of the modules, allowing the image to be transferred from the transfer intermediate member or the primary imaging member, depending on the design of the machine, to the fusing rollers. The transport web preferably also serves frictionally drive the modules, although they can be driven by other means such as gears, synchronously driven motors, or other means known in the art.

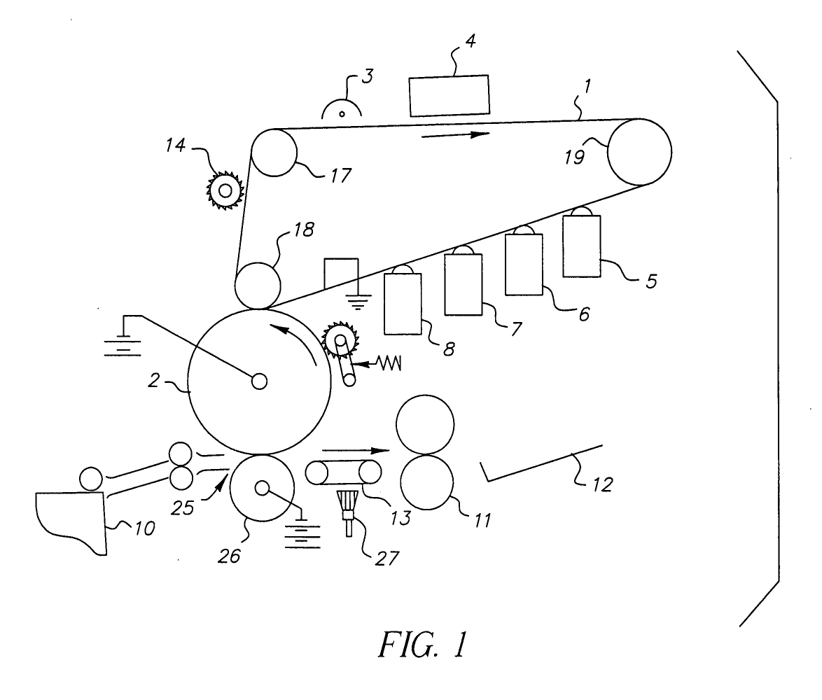

FIG. 1 illustrates an apparatus in which the invention is intended to be used. A primary imaging member 1 includes a photoconductive web trained about rollers 17, 18, and 19, one of which is drivable to move the photoconductive web past a series of stations well known in the electrophotographic art. Primary imaging member 1 is uniformly charged at a charging station 3, image-wise exposed at an exposure station 4, e.g., an LED print head or laser electronic exposure station, to create an electrostatic image. The image is toned by one of toner stations 5, 6, 7, or 8 to create a toner image corresponding to the color of toner in the station used. The toner image is transferred from the photoconductive web to an intermediate transfer member 2, for example, a blanket cylinder, at a transfer station formed by roller 18 of primary imaging member 1 and intermediate transfer member 2. The photoconductive web of primary imaging member 1 is cleaned at a cleaning station 14 and reused to form more toner images of different color utilizing toner stations 5, 6, 7, and 8. One or more additional images are transferred in registration with the first image transferred to intermediate transfer member 2 to create a multi-color toner image on its surface.

The multi-color image is transferred to a receiving sheet which has been fed from supply 10 into transfer relationship with intermediate transfer member 2 at transfer station 25. The receiving sheet is transported from transfer station 25 by a receiver transport member 13, preferably a transport web, to a fuser assembly 11 where the toner image is fixed by conventional means. The receiving sheet is then conveyed from fuser assembly 11 to an output tray 12.

The toner image is transferred from primary imaging member 1 to the intermediate transfer member 2 in response to an electric field applied between the core of the blanket cylinder including intermediate transfer member 2 and a conductive electrode that is contained in primary imaging member 1 and is grounded for convenience in cooperating with the other stations in forming the electrostatic and toner images. The multi-color toner image is transferred to the receiving sheet at transfer station 25 in response to an electric field created between a backing roller 26 and the intermediate transfer member 2, which thus helps establish both electric fields. If the toner is positively charged, an electrical bias applied to intermediate transfer member 2 of, typically, −1000 to −1500 volts will effect substantial transfer of toner images to intermediate transfer member 2. To transfer the toner image onto a receiving sheet at transfer station 25, a bias, e.g., −2000 volts, is applied to backing roller 26 to again urge the positively charged toner to transfer to the receiving sheet.

The receiver transport member 13 preferably is a transport web having a surface whose surface energy is about 14 ergs/cm² about 35 ergs/cm², preferably 25 ergs/cm² or less, more preferably, less than 18 ergs/cm^{2.} A surface energy of at least about 14 ergs/cm² for the surface of receiver transport member 13 ensures proper tracking of the modules and sufficient adhesion of the receiver to the web.

The surface energy of the transport web can be determined by measuring the contact angles of small droplets of distilled water and diiodomethane with the surface of the substrate being examined. A contact angle goniometer suitable for performing the required contact angle measurements is the VCA 2500, available from AST Products. In each measurement, a small droplet of the liquid is formed on the tip of the syringe used to dispense that liquid. The droplet is sufficiently small so as to preclude the droplet from falling off the syringe due to gravity. Immediately after formation of the droplet, the substrate is slowly raised towards the droplet until it just contacts the droplet. The substrate is immediately lowered, causing the droplet to separate from the syringe and reside on the substrate surface. The contact angles of the droplets of the aforementioned liquids with the surface, as determined by the geometric mean approximation of the AST software, are used to obtain the surface energy of the substrate.

The transport web can be formed substantially entirely from a material whose surface energy falls within the required range. It may be preferable, however, to use a composite material whereby the mechanical properties of the web can be separated from its surface energy characteristics. This facilitates choosing a material that is sufficiently strong, resistant to stretching, tough, etc. while also being able to obtain the correct surface energy. Suitable composite materials for the web include, for example, KAPTON®F, a TEFLON® coated polyimide produced by Dupont. In addition to fluoropolymers, other low surface energy materials include, for example, polyolefins such as polypropylene and polyethylene. Metallic belts coated with a low surface energy layer are also suitable transport webs. The low surface energy of the transport web can, if desired, be replenished within the apparatus by suitable means such as an applicator, aerosol deposition, etc., as is known in the art. In a preferred embodiment, the web includes an electrically insulating material that can be electrically charged by suitable means such as a corona or roller charger, tribocharging brush, etc., in such a manner so as to anchor the receiver to the web. In this way, the web can be used as both a drive mechanism and a receiver transport mechanism.

The removal of fuser oil from a receiver transport web whose surface energy is about surface whose surface energy is, in accordance with the present invention, no greater than about 35 ergs/cm² can be removed using a cleaning device 27 that is in cooperative association with receiver transport member 13. Cleaning device 27 includes a fabric such as a weft-inserted warp knit (WIWK) microfiber fabric that can be formed from a variety of polymeric materials, including acrylic polymers, polyesters, polyamides, nylon, polypropylene, and combinations thereof. Preferably, the microfiber fabric includes a polyester.

A suitable material for use in cleaning device 27 is, for example, a SCOTCH-BRITE® High Tech Cleaning Cloth, available from 3M. Although such a cleaning device could be conceivably be used to remove release oil from other components or assemblies such as primary imaging member 1 or intermediate transfer member 2, it is especially advantageous and convenient to employ it for removing oil from the web including receiver transport member 13.

Although residual release oil can be removed from receiver transport member 13 simply by wiping it with a cloth made of the (WIWK) microfiber fabric, it is preferable to make a cleaning member by, for example, cutting the cloth into strips and assembling said them around an arbor. During cleaning, the arbor would spun so that the strips of cloth will flap against the surface of the transport web, thereby facilitating the removal of at least a substantial portion of the residual oil.

Complete removal of residual oil from the surface of receiver transport member 13, while desirable, is not necessary to obtain a desirable benefit in the quality of the toner images produced by the apparatus.

The following examples serve to illustrate the invention:

### Example 1

The surface energy of a KAPTON®H polyimide sheet (from Dupont), measured as described above, was about 48 ergs/cm². Infrared spectroscopy of the surface showed no silicone present. Several small droplets of A 7087 fuser oil (from Walker Silicone), a blend of amine-terminated and regular silicone oils having a viscosity of 320 cs and a surface tension of approximately 25 mN/m, hereafter referred to simply as “silicone oil”, was deposited onto the KAPTON®H surface using a syringe from the contact angle goniometer described above.

After the oil had been spread on the surface, it was vigorously wiped, using a HANDI-WIPE® cotton pad (from Webril) to remove as much of the oil as possible. The KAPTON®H surface was then again wiped with a 3M SCOTCH-BRITE® High Tech cleaning cloth, and the surface energy of the sheet was determined as previously described. The obtained value, about 26 ergs/cm², is consistent with the KAPTON®H surface being substantially completely coated with silicone oil, showing that the 3M cloth could not remove all the oil from a control sheet having a high initial surface energy. Infrared spectroscopy also showed the presence of silicone oil, even though not detectable by eye, on the KAPTON®H surface after it had been cleaned with the 3M cloth.

### Example 2

This example is similar to Example 1, except that a sheet of KAPTON®F (from Dupont), a polyimide that is surface coated with TEFLON®, was used as the substrate. The surface energy of the KAPTON®F sheet was measured and found to be about 17 ergs/cm², a value consistent with the value of 18.5 ergs/cm² normally cited for TEFLON®.

The silicone oil was applied to the KAPTON®F sheet as described in Example 1, and the surface was wiped with the 3M cloth. Surface energy measurement of the wiped surface gave a value of about 20 ergs/cm², which corresponds to only about one-third of the surface of the KAPTON®F sheet being coated with oil. Thus the 3M cloth was quite effective in removing the silicone oil from the low surface energy KAPTON®F sheet. Although not all the silicone oil was removed from the substrate surface, the removal of a substantial portion of the oil would be expected to result in a significant improvement in the quality of toner images from the apparatus.

### Example 3

To gain some understanding related to the transfer of fuser oil from one member to another in an electrostatographic apparatus, oil was applied to a sheet of KAPTON®H, referred to as “donor sheet 1” in a similar manner to that described in Example 1. After donor sheet 1 had been wiped first with a HANDI-WIPE® cotton pad and then with a 3M SCOTCH-BRITE® High Tech Cleaning Cloth to remove as much of the applied oil as possible, the wiped surface was placed in contact with a second sheet of KAPTON®H, referred to as “receiver sheet 1”. The two sheets were fed through the nip formed by a pair of fusing rollers at room temperature. Immediately upon exiting the nip, the sheets were separated. Surface energy measurements were carried out on the receiver sheet 1, which was redesignated “donor sheet 2” and placed in contact with a new sheet of KAPTON®H, referred to as “receiver sheet 2”. This procedure of using a previously designated receiver sheet as the donor sheet for lamination to a new receiver sheet of KAPTON®H was repeated several times, surface energy measurements being carried out on each donor sheet.

The results of these measurements for donor sheets 1-5 of Run 1 and 1-3 of Run 2, which are graphically depicted in FIG. 2, show that significant amounts of oil can be transferred from one high surface energy KAPTON®H donor sheet to another through 3-4 repetitions. Although the measured surface energies increased through the sequence of donor sheets, the value of clean KAPTON®H, 48 ergs/cm², was not achieved, demonstrating the difficulty of removing oil from a substrate having a high surface energy. As the surface energy of KAPTON®H approximates that of most of the members included in an electrostatographic reproduction apparatus, one would expect that removal of oil from the surfaces of such members would also difficult.

### Example 4

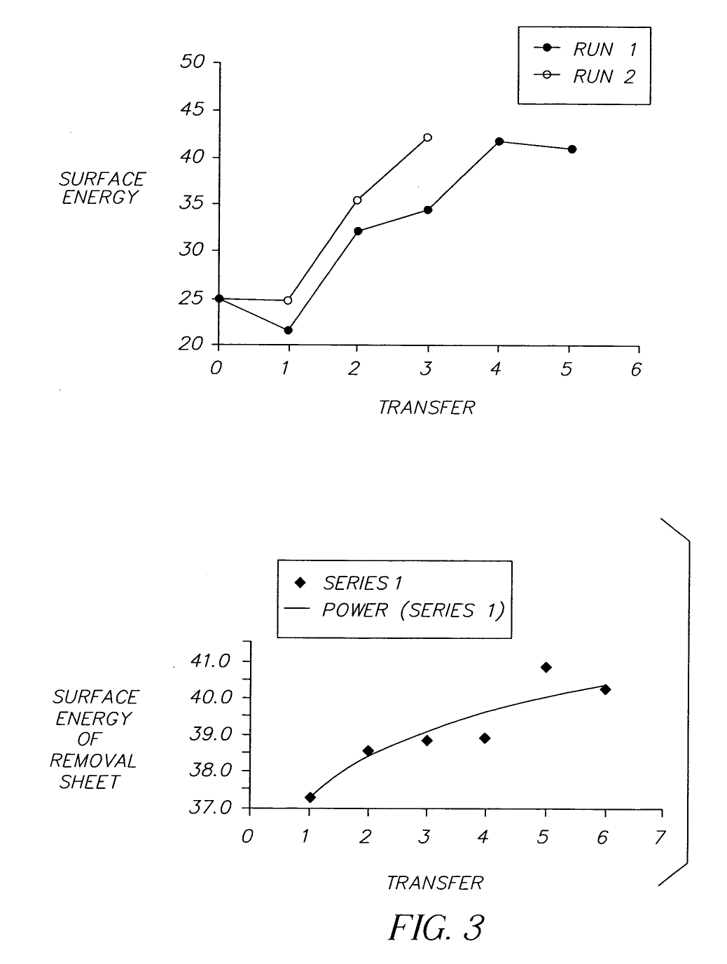

Silicone oil was applied to a KAPTON®H donor sheet in the manner described in Example 3. In this example, however, the oiled and wiped surface of the KAPTON®H donor sheet was repeatedly pressed against fresh acceptor sheets 1-6 of KAPTON®H, using the same set of rollers as were used in Example 3. The surface energies of the successive acceptor sheets were then measured. As shown by the results depicted in FIG. 3, the surface energies of the acceptor sheets, even after 6 contacts, were still noticeably lower than the value of 48 ergs/cm² measured for fresh KAPTON®H, indicating the continuing availability of silicone oil on the KAPTON®H donor sheet for incremental transfer to a series of acceptor sheets. These results further illustrate the difficulty in removing applied silicon oil from a high surface energy substrate such as KAPTON®H.

### Example 5

Silicone fuser oil was applied to a KAPTON®H sheet, which was then cleaned by wiping well with first with a HANDI-WIPE® cotton pad and then with a 3M SCOTCH-BRITE® High Tech Cleaning Cloth. The surface energy of the cleaned KAPTON®H sheet was measured, giving a value of about 26.8 ergs/cm², which is consistent with the value expected if the surface of the sheet were substantially totally coated with the silicone oil. The oiled surface of the cleaned KAPTON®H sheet was then pressed against a sheet of KAPTON®F, and the sheets were sent through the rollers as described in the previous examples. Upon separation of the two sheets, the measured surface energy of the KAPTON®H sheet was 28 ergs/cm², which is virtually the same as that observed before the contacting of the sheets. Moreover, the surface energy of the KAPTON®F sheet was found to be 17.5 ergs/cm², which is the expected value of clean, i.e. no oil present, of KAPTON®F. Thus no detectable amount of oil was transferred from the high surface energy KAPTON®H sheet to the low surface energy KAPTON®F sheet when they were placed in contact through the rollers.

The invention has been described in detail with particular reference to certain preferred embodiments thereof, but it will be understood that certain variations and modifications can be effected within the spirit and scope of the invention, which is defined by the claims that follow.

What is claimed:

1. An electrostatographic reproduction apparatus comprising:
a primary imaging member for forming a toner image;
a fuser assembly that comprises a fusing member and a pressure member for fixing said toner image to a receiver;
a release oil device for delivering release oil to said fusing member;
an intermediate transfer member for receiving said toner image from said primary imaging member;
a receiver transport member for transporting said toner image from said intermediate transfer member to said fuser assembly, said receiver transport member having a surface energy from about 14 ergs/cm² to about 35 ergs/cm²; and
a cleaning device in operative association with said receiver transport member, said cleaning device comprising a fabric material capable of removal of residual release oil from said receiver transport member.

2. The apparatus of claim 1, wherein said receiver transport member has a surface energy from about 14 ergs/cm² to about 25 ergs/cm².

3. The apparatus of claim 2, wherein said receiver transport member has a surface energy from about 14 ergs/cm² to about 18 ergs/cm².

4. The apparatus of claim 1, wherein said receiver transport member comprises a polymeric web.

5. The apparatus of claim 4, wherein said polymeric web comprises a fluoropolymeric surface layer.

6. The apparatus of claim 4, wherein said polymeric web comprises a polyolefinic surface layer.

7. The apparatus of claim 1, wherein said fabric material comprises a weft inserted warp knit microfiber fabric.

8. The apparatus of claim 7, wherein said weft inserted warp knit microfiber fabric comprises a polyester.

9. The apparatus of claim 7, wherein said weft inserted warp knit microfiber fabric is formed from a polymeric material selected from the group consisting of acrylic polymers, polyesters, polyamides, nylon, polypropylene, and combinations thereof.

10. The apparatus of claim 1, wherein said fabric material included in said cleaning device is replaceable.

11. The apparatus of claim 1, wherein said release oil comprises silicone oil.
